(19) United States
(12) Patent Application Publication
(10) Pub. No.: US 2020/0209474 A1
(43) Pub. Date: Jul. 2, 2020

(54) OPTICAL BRANCHING/COUPLING DEVICE, MANUFACTURING METHOD FOR SAID OPTICAL BRANCHING/COUPLING DEVICE, LIGHT SOURCE DEVICE AND LIGHT EMITTING DEVICE USING SAID OPTICAL BRANCHING/COUPLING DEVICE

(71) Applicants: ADAMANT NAMIKI PRECISION JEWEL CO., LTD., Tokyo (JP); DENSO CORPORATION, Kariya-shi, Aichi (JP)

(72) Inventors: Hiroyuki FUJIWARA, Kawaguchi-shi, Saitama (JP); Masaru SASAKI, Kawaguchi-shi, Saitama (JP); Kaoru TORII, Adachi-ku, Tokyo (JP); Ren WATANABE, Toda-shi, Saitama (JP); Mitsuhiko MIZUNO, Kasugai-shi, Aichi (JP)

(21) Appl. No.: 16/081,344

(22) PCT Filed: Mar. 8, 2017
(86) PCT No.: PCT/JP2017/009346

§ 371 Date: Aug. 30, 2018

(30) Foreign Application Priority Data
Mar. 9, 2016 (JP) 2016-045213

(51) Int. Cl. G02B 6/125; G02B 6/30; G02B 6/42

(52) U.S. Cl. CPC G02B 6/125; G02B 6/4204; G02B 6/30

(57) ABSTRACT

An optical branching/coupling device includes a single first port that has an optical fiber; a plurality of second ports each having an optical fiber and arranged at the periphery of the optical axis of the first port, in locations that are removed from the first port in an optical axis direction; a core layer that transmits light between the first port and the second ports; and a cladding layer that covers the periphery of the core layer, wherein the core includes a plurality of optical waveguides, one end side of the optical waveguides being connected to each core of the plurality of second ports, and another end side of the optical waveguides joining together and being connected to a core of the first port, and the optical waveguides are a cured product of a photocuring resin.

### TECHNICAL FIELD

The present invention relates to an optical branching/coupling device usable as a light branching device, a light coupling device, etc., a manufacturing method for the optical branching/coupling device, and a light source device and a light emitting device using the optical branching/coupling device.

### BACKGROUND ART

Conventionally, in this type of invention, for example, as described in Patent Literature 1, there is an optical branching transmission path configured so that an incidence portion in which a plurality of optical fibers are bundled is coupled to a light emitting element via a plurality of lens systems, and the plurality of optical fibers on the emission end side are individually separated and coupled to the light receiving elements of the processor boards respectively and the bundled optical fibers at the incidence portion are fused with each other

### CITATION LIST

### Patent Literature

Patent Literature 1: JP 06-265747 A

### SUMMARY OF INVENTION

### Technical Problem

However, in the above-described conventional technique, equipment for bundling and fusing a plurality of optical fibers may be expensive in some cases. Thus, it is conceivable to use optical components such as filters and mirrors so as to collect the light emitted from a plurality of optical fibers into a single optical fiber, but such a configuration is not desirable because each optical component is expensive, and in addition the alignment between the optical components requires man-hours.

### Solution to Problem

In view of such a problem, the present invention has the following structure.

An optical branching/coupling device including: a single first port made of an optical fiber; a plurality of second ports made of optical fibers and arranged around an optical axis of the first port at positions away from the first port in a direction of the optical axis; a core layer for transmitting light between the first port and the second ports; and a cladding layer covering a periphery of the core layer, wherein the core layer includes a plurality of optical waveguides, ends on one end side of which are connected to cores of the plurality of second ports respectively and ends on the other end side of which are combined with each other to be connected to a core of the first port, and the optical waveguides are cured products of a photocuring resin.

### Advantageous Effects of Invention

By using the basic structure described above, the optical branching/coupling device of the present invention can make the optical waveguide by itself by inputting light during the manufacture of the optical branching/coupling device. Further, the waveguide can be connected to a plurality of optical axes not in the same straight line by using self-alignment. In addition, the optical branching/coupling device can be configured without using optical components such as filters and mirrors.

That is to say, with such a structure, an optical branching/coupling device can be manufactured by self-forming waveguide technique in the structure described in the present invention.

### BRIEF DESCRIPTION OF DRAWINGS

FIG. 1 is a perspective view showing an internal structure of an example of an optical branching/coupling device according to the present invention.

FIG. 2 is a cross-sectional view of a joining portion of an optical waveguide and a first port.

FIG. 3 is a diagram sequentially showing a part of the manufacturing procedure of the optical branching/coupling device according to the present invention in (a) and (b).

FIG. 4 is a schematic diagram showing a structure of an example of a light source device and a light emitting device according to the present invention.

### DESCRIPTION OF EMBODIMENTS

Embodiments of the present invention will be described below with reference to the drawings. Hereinafter, the same reference numerals in the different drawings indicate the same portions, and redundant description will be omitted as appropriate.

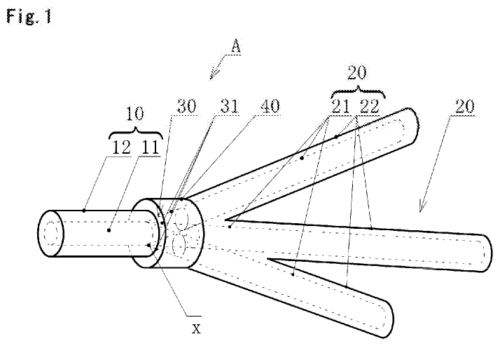

FIG. 1 shows an example of an optical branching/coupling device according to the present invention.

This optical branching/coupling device A includes a single first port 10, a plurality of second ports 20 arranged around the optical axis of the first port 10 at positions away from the first port 10 in the optical axis direction, a core layer 30 that transmits light between the first port 10 and the second ports 20, and a cladding layer 40 that covers the periphery of the core layer 30.

The first port 10 and the plurality of second ports 20 are optical fibers that have clads 12 and 22 having refractive indices lower than those of cores 11 and 21 around the cores 11 and 21, respectively.

The plurality of second ports 20 have substantially the same core diameter.

The core diameter of the first port 10 is larger than the core diameter of the second port 20.

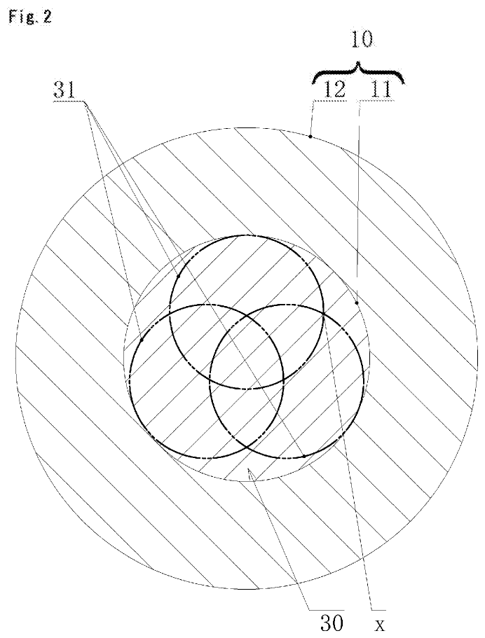

The first port 10 has one end (the right end side in FIG. 1) facing toward substantially the center of the core layer 30 to be described later, and this one end is connected to the end face of the core layer 30 (see FIGS. 1 and 2).

Each of the plurality of second ports 20 is arranged in an inclined manner so that an end on the other end side (the left end side in FIG. 1) thereof opposite to an end on the one end side which is the light incidence/emission end faces toward the core 11 of the first port 10, and the ends on the other end side are connected to the end faces of a plurality of optical waveguides 31 respectively. The second ports 20 may also be arranged in parallel.

The core layer 30 is composed of the plurality of (three in the illustrated example) optical waveguides 31 arranged around the optical axis of the first port 10.

The ends on one end side (the right end side in FIG. 1) of the plurality of optical waveguides 31 are connected to the cores 21 of the plurality of second ports 20 respectively, and the ends on the other side (the left end side in FIG. 1) are connected to the core 11 of the first port 10 so as to be coupled together on the optical axis of the first port 10.

Each optical waveguide 31 is a cured product of a first photocuring resin.

The first photocuring resin has only to be a photocuring resin that is cured by light having a wavelength of 400 nm to 500 nm, for example, and can be one that is used in a general self-forming waveguide technique.

The end on the one end side (the right end side in FIG. 1) of each optical waveguide 31 has a diameter substantially equal to that of the core of the corresponding second port 20.

As shown in FIG. 2, the ends on the other side (the left end side in FIG. 1) of the plurality of optical waveguides 31 are combined so as to be made close to the center of the first port 10 and overlapped with each other, and the end face of a combining portion x is connected to the core 11 of the first port 10.

In the preferable example shown in FIG. 2, the end face of the joining portion x is located in the core 11, but the end face of the joining portion x may partially protrude outside the core 11 in some cases.

The cladding layer 40 is a cured product of a second photocuring resin different from the first photocuring resin, and the refractive index n2 of the cladding layer 40 is smaller than the refractive index n1 of the core layer 30. The second photocuring resin has only to be a photocuring resin that is cured by irradiation with ultraviolet light. Incidentally from the same technical point of view, a material having a refractive index lower than that of the first photocuring resin, such as a thermosetting resin, air or water can be used for the second photocuring resin.

The cladding layer 40 is provided so as to cover the entire periphery of the core layer 30, and the end on the one end side in the optical axis direction is connected to the clad 22 of each second port 20 and the end on the other end side is connected to the clad 12 of the first port 10.

This cladding layer 40 can be formed into, for example, a cylindrical shape, a prismatic shape, or any other three-dimensional shape depending on the inner surface shape of a container 50 to be described later.

The first photocuring resin and the second photocuring resin constituting the core layer 30 and the cladding layer 40 can be appropriately selected from, for example, the photocuring resin described in Patent Literature 1 or other well-known photocuring resins.

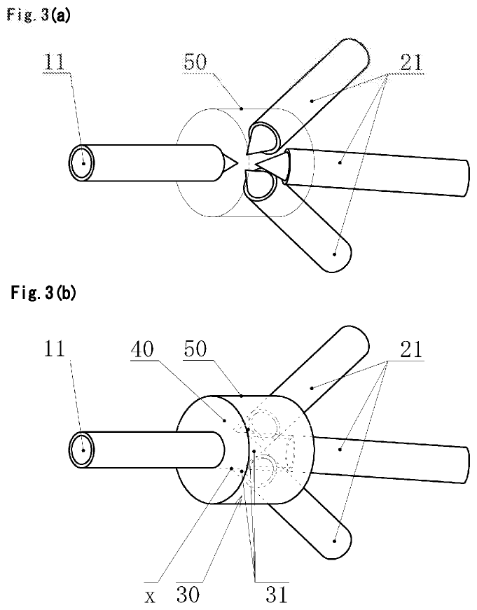

Next, the manufacturing method for the optical branching/coupling device A having the above-described structure will be described in detail with reference to FIG. 3.

In this manufacturing method, used are the first port 10, the plurality of second ports 20 arranged around the optical axis of the first port 10 at positions separated from the first port 10 in the optical axis direction, and the container 50 which covers the space between the first port 10 and the plurality of second ports 20 and covers the tip of each port on the space side.

The first port 10, the plurality of second ports 20, and the container 50 are arranged so as to form the optical branching/coupling device A described above, and are fixed to be immovable with respect to each other by a jig or the like.

The container 50 is formed in a hollow three-dimensional shape which forms the outer surface shape of the cladding layer 3 by its inner surface. The container 50 may be made of a hard material such as a metal, a hard synthetic resin, ceramics, glass or the like, and windows, openings, or the like that transmit ultraviolet light are provided as necessary.

Through holes through which the ends of the plurality of second ports 20 are inserted are formed on the one end side (the second port 20 side) of the container 50.

In addition, a through hole through which the end of the first port 10 is inserted is formed on the other end side (the first port 10 side) of the container 50.

The wail of this container 50 is provided with an opening (not shown) for filling the container with the first and second photocuring resins or removing the uncured photocuring resin.

A light source emitting laser light having a wavelength of 400 nm to 500 nm for example is connected to each of the end on the other end side (the left end side in the illustrated example) of the first port 10 and the end on the one end side (the right end side in the illustrated example) of each of the second ports 20.

As for the production procedure in detail, first, the container 50 is filled with the first photocuring resin.

Next, the laser light of the above-mentioned light source is made incident on the end face on the other end side (the left end side in the illustrated example) of the first port 10, and this light is emitted from the end face on the second port 20 side of the core of the first port 10.

At the same time, the laser light of the light source is made incident on the end face on the one end side (the right end side in the illustrated example) of the second port 20, and this light is emitted from the end face on the first port 10 side of the core of each second port 20.

Accordingly, the first photocuring resin between the first port 10 and the second ports 20 is hardened, and as shown in FIGS. 3(a) and 3(b), the plurality of optical waveguides 31 that linearly connect the core of the first port 10 and the core of each second port 20 are formed between the first port 10 and the plurality of second ports 20.

The optical waveguides 31 have the joining portion x on the first port 10 side and constitute the branched core layer 30, the one end on the one end side of which is branched.

The uncured first photocuring resin remaining in the container 50 is removed, and the container 50 is filled with the second photocuring resin so that the resin covers the previously formed core layer 30 over the entire circumference (refer to FIG. 3(b)).

The second photocuring resin filling the container is cured by the ultraviolet light emitted from the light source lateral to the container 50 to form the cladding layer 40.

Thereafter, the container 50, the light source, etc. are removed, and the optical branching/coupling device A (see FIG. 1) is completed.

The container 50 can also be used as a housing for protecting the cladding layer 40 and the like without being removed.

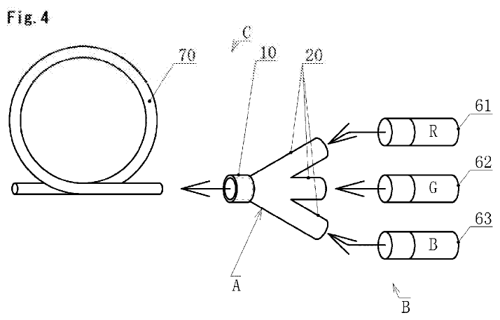

The optical branching/coupling device A having the above structure constitutes a part of a light source device B and a light emitting device C shown in FIG. 4, for example.

The light source device B is composed of the optical branching/coupling device A having the above-described configuration and a plurality of independent light source units 61, 62 and 63 connected to the plurality of second ports 20 of the optical branching/coupling device A, respectively.

The light emitting device C is composed of the light source device B and a light emitter 70 that radiates light emitted from the light source device B.

The plurality of light source units include the light source unit 61 that emits light of a wavelength that makes the light color to be perceived as red (for example, 633 nm), the light source unit 62 that emits light of a wavelength that makes the light color to be perceived as green (for example, 532 nm) and the light source unit 63 that emits light of a wavelength that makes the light color to be perceived as blue (for example, 450 nm).

According to a preferable example of the present embodiment, a light source emitting a laser beam is used in the light source units 61, 62, and 63.

The light emitter 70 is an elongated shaft-shaped flexible optical fiber that radiates light from the outer surface due to the light passing through the inside of the light emitter 70.

This light emitter 70 can be, for example, a Fibrance (trademark) manufactured by Corning Inc. or any other well-known optical fiber for illumination.

Further, as another example of the light emitter 70, one having no flexibility or having a shape other than a shaft shape can be used.

Therefore, according to the optical branching/coupling device A having the above-described structure, the first port 10 and the plurality of second ports 20 can be connected without using a high-cost and large-scale fusing apparatus.

In addition, since optical parts such as a half mirror and a WDM filter are not used, a relatively inexpensive configuration can be obtained.

Further, by connection of the light source units 61, 62 and 63 for constituting the light source device B and the light emitting device C, mixed color light and white light can be easily output.

It should be noted that the present invention is not limited to the above-described embodiments, and can be appropriately modified without changing the gist of the present invention.

### REFERENCE SIGNS LIST

10: first port

11: core

12: clad

20: second port

21: core

22: clad

30: core layer

31: optical waveguide

40: cladding layer

50: container

61, 62, 63: light source unit

70: light emitter

x: joining portion

A: optical branching/coupling device

B: light source device

C: light emitting device

1. An optical branching/coupling device comprising:
a single first port made of an optical fiber;
a plurality of second ports made of optical fibers and arranged around an optical axis of the first port at positions away from the first port in a direction of the optical axis;
a core layer for transmitting light between the first port and the second ports; and
a cladding layer covering a periphery of the core layer, wherein
the core layer includes a plurality of optical waveguides, ends on one end side of which are connected to cores of the plurality of second ports respectively and ends on an other end side of which are combined with each other to be connected to a core of the first port, and the optical waveguides are cured products of a photocuring resin.

2. The optical branching/coupling device according to claim 1, wherein the cladding layer is a cured product of a photocuring resin different from the photocuring resin that forms the optical waveguides, while having a refractive index smaller than a refractive index of the core layer, and covers each cladding layer of the plurality of second ports on the one end side in the optical axis direction while covering a cladding layer of the first port on the other end side.

3. A method for manufacturing the optical branching/coupling device according to claim 1 by using the first port, the plurality of second ports arranged around the optical axis of the first port at positions away from the first port in the optical axis direction, and a container covering a space between the first port and the plurality of second ports and also covering a tip of each of the first and second ports, which faces the space, the method comprising
forming the plurality of optical waveguides by curing a first photocuring resin filling in the container by light having passed between the first port and the plurality of second ports.

4. The method for manufacturing the optical branching/coupling device according to claim 3 wherein the forming step comprises curing the first photocuring resin by using both first light made incident from the first port and second light made incident from each of the plurality of second ports so as to be opposed to the first light.

5. The method for manufacturing the optical branching/coupling device according to claim 3 further comprising forming the cladding layer by removing an uncured resin in the container after forming the optical waveguides, filling the container with the second photocuring resin and curing the second photocuring resin using light emitted from an outside of the container.

6. A light source device comprising:
the optical branching/coupling device according to claim 1; and
a plurality of light source units connected to the plurality of second ports of the optical branching/coupling device respectively so as to be each paired with each of the plurality of second ports.

7. The light source device according to claim 6, wherein the plurality of light source units include a light source unit that emits light of a wavelength that makes a light color to be perceived as red, a light source unit that emits light of a wavelength that makes a light color to be perceived as green, and a light source unit that emits light of a wavelength that makes a light color to be perceived as blue.

8. A light emitting device comprising:
the light source device according to claim 6; and
a light emitter that is connected to the first port and that radiates light by light emitted from the first port.

9. A method for manufacturing the optical branching/coupling device according to claim 2 by using the first port, the plurality of second ports arranged around the optical axis of the first port at positions away from the first port in the optical axis direction, and a container covering a space between the first port and the plurality of second ports and also covering a tip of each of the first and second ports, which faces the space, the method comprising
forming the plurality of optical waveguides by curing a first photocuring resin filling in the container by light having passed between the first port and the plurality of second ports.

10. The method for manufacturing the optical branching/coupling device according to claim 9 wherein the forming step comprises curing the first photocuring resin by using both first light made incident from the first port and second light made incident from each of the plurality of second ports so as to be opposed to the first light.

11. The method for manufacturing the optical branching/coupling device according to claim 9 further comprising forming the cladding layer by removing an uncured resin in the container after forming the optical waveguides, filling the container with the second photocuring resin and curing the second photocuring resin using light emitted from an outside of the container.

12. A light source device comprising:
the optical branching/coupling device according to claim 2; and
a plurality of light source units connected to the plurality of second ports of the optical branching/coupling device respectively so as to be each paired with each of the plurality of second ports.

13. The light source device according to claim 12, wherein the plurality of light source units include a light source unit that emits light of a wavelength that makes a light color to be perceived as red, a light source unit that emits light of a wavelength that makes a light color to be perceived as green, and a light source unit that emits light of a wavelength that makes a light color to be perceived as blue.

14. A light emitting device comprising:
the light source device according to claim 12; and
a light emitter that is connected to the first port and that radiates light by light emitted from the first port.
